(19) United States
(12) Patent Application Publication
(10) Pub. No.: US 2011/0037590 A1
(43) Pub. Date: Feb. 17, 2011

(54) SYSTEM AND APPARATUS FOR DELIVERING EMERGENCY ALERT MESSAGES AS A SERVICE CONTENT IN A BROADCAST NETWORK

(75) Inventor: PRASANNA KANNAN, San Diego, CA (US)

Correspondence Address: McDermott Will & Emery LLP, 600 13th Street, NW, Washington, DC, 20005-3096, US

(73) Assignee: QUALCOMM Incorporated, San Diego, CA (US)

(21) Appl. No.: 12/726,893

(22) Filed: Mar. 18, 2010

Related U.S. Application Data
(60) Provisional application No. 61/233,224, filed on Aug. 12, 2009.

(51) Int. Cl. G08B 1/08; H04W 40/00; H04L 12/26

(52) U.S. Cl. 340/539.13; 370/328; 370/252

(57) ABSTRACT

Embodiments enable mobile multimedia receiver devices to receive emergency alert messages from forward link only broadcast networks. Alert messages may be organized in alert sessions identified by an alert session ID. Alert record information may be included in the overhead information symbol (OIS) channel including the session ID and information enabling a receiver device to obtain an alert data message from an alert session in a multicast logic channel. The alert announcement may also be included in the service flow MLCs as an embedded OIS in a first superframe. The alert record may include the number of alert data packets the alert session so receiving devices can determine when they have received all data packets associated with a particular alert. By storing the alert session identifier in memory, receiving devices can ignore subsequent broadcasts of the same alert, thereby enabling them to conserve battery power.

### RELATED APPLICATIONS

This application claims the benefit of priority to U.S. Provisional Application No. 61/233,224 entitled “System And Apparatus For Delivering Emergency Alert Messages As A Service Content In A Broadcast Network” filed Aug. 12, 2009, the entire contents of which are hereby incorporated by reference.

### TECHNICAL FIELD

The present invention relates generally to the operation of mobile wireless networks, and more particularly to methods and systems for delivering emergency alerts as a broadcast service.

### BACKGROUND

Wireless communication technologies have seen explosive growth over the past few years. This growth has been fueled by wireless services providing freedom of movement to the mobile public, and cutting the tether to hardwired communication systems. As a result of service enhancements, the popularity of wireless services is expected to continue to grow rapidly. A recent addition to wireless communication services has been the ability to broadcast television and other content to receiver devices. FLO broadcast services allow users to view TV programming, as well as receive mobile editions of news, entertainment, sports, business, and other programming, using their cell phone or other wireless receiver device configured to receive the mobile broadcast transmissions. The growth of multimedia broadcast services represents an attractive communication platform for delivering emergency alert messages to the public.

### SUMMARY

The various embodiments enable mobile multimedia receiver devices to receive emergency alert messages from forward link only broadcast networks. Alert messages may be organized in alert sessions identified by an alert session ID. An alert record information may be included in the overhead information symbol (OIS) channel including the session ID and information enabling a receiver device to obtain an alert data message from an alert session in the multicast logic channel (MLC). The alert record may also be included in the MLC as an embedded OIS in a first superframe. The alert record may include the number of alert data packets in the alert session so receiving devices can determine when they have received all data packets associated with a particular alert. By storing the alert session identifier in memory, receiving devices can ignore subsequent broadcasts of the same alert, thereby enabling them to conserve battery power.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a FLO broadcast communication system suitable for use in an embodiment.

FIG. 2 is an alternative representation of a communication system block diagram of a FLO broadcast system.

FIGS. 3A and 3B are diagrams of a multimedia broadcast superframe illustrating message contents including placement of alert message information.

FIG. 4 is diagram of a sequence of communication superframes illustrating an embodiment method for including alert information in broadcast transmissions in order to promptly notify the receiver devices of an alert.

FIG. 5 is a process flow diagram of an embodiment method for inserting alert message information into broadcast transmissions.

FIG. 6 is diagram of a sequence of communication superframes illustrating an alternative embodiment method for including alert information in broadcast transmissions in order to promptly notify the receiver devices of an alert.

FIG. 7 is a process flow diagram of an alternative embodiment method for inserting alert message information into broadcast transmissions.

FIG. 8 is a process flow diagram of an embodiment method for receiving alert messages within a multimedia receiver device.

FIG. 9 is a process flow diagram of an embodiment method for determining whether an alert is pertinent based upon geographic information.

FIG. 10 is a process flow diagram of an embodiment method for determining whether an alert is pertinent based upon the alert type or topic information.

FIG. 11 is a combination of a software architecture diagram and a message architecture diagram illustrating how alert messages may be translated into communication packets according to an embodiment.

FIG. 12 is a component block diagram of a receiver device suitable for use in an embodiment.

FIG. 13 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “receiver device” is used herein to refer to any one or all of mobile media broadcast receivers, cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, personal television devices, receivers within vehicles (e.g., automobiles) and similar personal electronic devices which include a programmable processor and memory and FLO broadcast receiver circuitry for receiving and processing FLO broadcast transmissions such as MediaFLO® broadcasts.

The word “broadcast” is used herein to mean the transmission of data (information packets) so that it can be received by a large number of receiving devices simultaneously. Examples of a broadcast message are mobile television service broadcast signals, including content broadcasts (content flow) and overhead information broadcasts (overhead flow) such as metadata messages.

Mobile multimedia receiver devices are different from traditional television sets in that the receiver devices are portable. Consequently, receiver devices configured to receive FLO broadcast services must be self-contained and designed to operate for extended periods of time on battery power. The need to be battery powered presents unique challenges to FLO broadcast systems. FLO broadcast networks broadcast information in formats that enable receiver devices to selectively tune-in to receive desired content or to de-energize their broadcast receiver whenever the desired content is not being broadcast. To address this need, information about programs and content are broadcast in advance in an overhead flow so that receiver devices can determine just when to tune-in to receive a selected service within the content flow. As a result of this data transmission structure, mobile multimedia receiver devices typically activate their receiver circuitry for a small percentage of the time, thereby reducing the amount of power required to receive desired content.

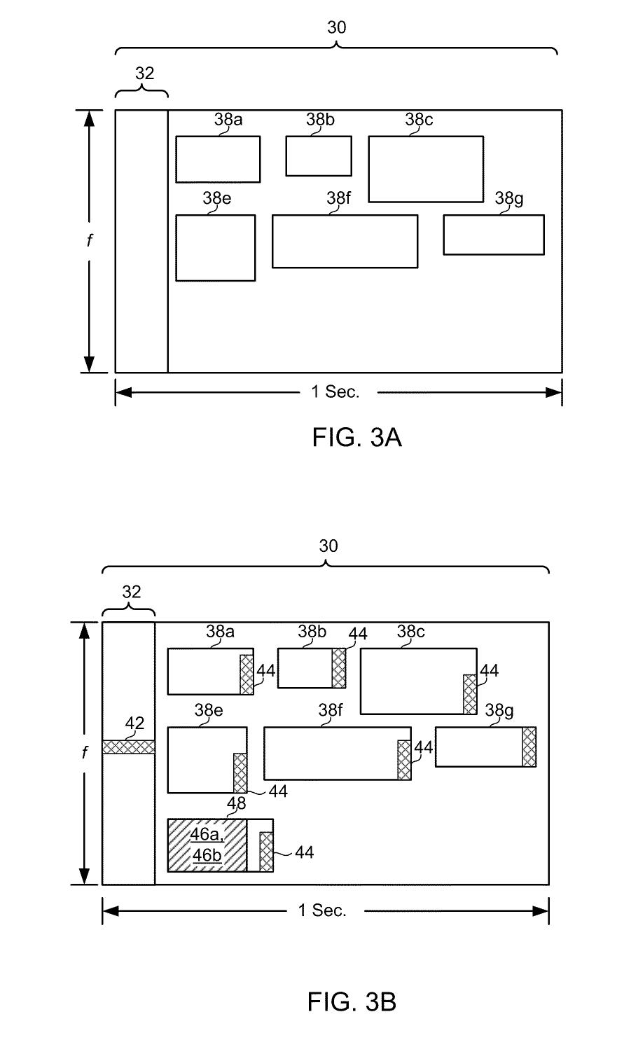

FLO broadcast services, such as services provided by FLO broadcast networks, enable mobile receiver devices to be self-contained by broadcasting information about the programs and content that will be broadcast in the future. The information about upcoming programs is broadcast in a portion of broadcast transmissions dedicated to carrying overhead information, which is referred to herein as the “Overhead Information Symbol” channel or OIS channel. Programs and content are carried in the data channel which is referred to herein as the “Multicast Logic Channel” or MLC channel. In operation, receiver devices use information carried in the OIS channel about the content to be broadcast in the MLC channel to discover how and when to receive selected content. Information in the OIS channel informs receiver devices about the location within the MLC channel that particular content can be obtained, as well as its transmission characteristics. More information regarding the structure of the OIS and MLC channels is provided below with reference to FIG. 3.

The various embodiments enable the transmission of emergency alert messages in an emergency alert service flow by a Forward Link Only (FLO) multimedia broadcast network for reception and prompt processing by receiver devices. The embodiments may be implemented in any broadcast network using both a content channel and an overhead channel, but are particularly applicable to a FLO broadcast network as defined in the Telecommunications Industry Association specifications TIA-1120 and TIA-1099, which are both hereby incorporated by reference in their entirety.

In the various embodiments, an alert message received from a governmental alert gateway, or other source of alerts, may be used to generate alert data that may be transmitted within a stream of the MLC channel and alert message acquisition information which will be transmitted in the OIS channel. Transmitting the alert message acquisition information in the OIS channel ensures that any receiver device accessing the OIS channel will immediately receive the alert message data included in the MLC channel. To ensure reception occurs within two superframes of broadcast transmissions, alert message acquisition information may also be included within content in the MLC channel in a first superframe, so that receiver devices monitoring content in the MLC channel will be informed that the next superframe will include alert message data. The alert message acquisition information within the OIS channel indicates the physical channel on which the receiver device can acquire the alert stream within the MLC channel and the transmission characteristics of the physical channel carrying messages. To enable receiver devices to conserve battery power by avoiding the need to monitor alert messages that have already been received, alert messages may be identified with an alert session ID which may be included in the alert message acquisition information in the OIS channel. To facilitate acquisition of the entire alert message, the alert message acquisition information in the OIS channel may indicate the number of alert messages within a particular alert session (i.e., associated with a particular alert session ID). Using the session ID and alert message number information in the alert message acquisition information, a receiver device can determine whether it has already received a particular alert message, and thus activate its radio receiver only when necessary to receive a new alert message. To more efficiently utilize broadcast bandwidth, the various embodiments may enable multiplexing alert messages with other data streams within the MLC channel.

The various embodiments enable receiver devices to efficiently receive emergency alert messages by monitoring the emergency alert service flow. Alert messages may be received from an external alert gateway that is part of the FLO broadcast network using standard alert ingress interfaces, such as CMAS-C and NCMEC Amber Alert. A wide variety of alert messages may be handled by the system, including earthquake warnings, tsunami warnings, severe weather alerts, flash flood alerts, evacuation alerts, terror event warnings, pollution alerts and general public advisories. The alert messages may be received via an emergency alert service application layer in an alert server within a broadcast system. The alert server may indicate the FLO broadcast network components that will broadcast the alert messages for the requested duration at an appropriate quality of service (QoS) through deployment specific interfaces. Alert messages may be processed in an alert session layer in the alert server which prefixes emergency alert service session headers to alert messages to generate alert session packets that are provided to the transport layer of the FLO broadcast network. Alert session packets may be fragmented by the transport layer into transport layer frames which are delivered to the physical layer for broadcast. The physical layer broadcasts the transport layer frames as physical layer packets.

In the various embodiments the alert message data may be transmitted in an alert session layer as an alert session. An alert session may include a set of alert messages, which may include alerts specific to particular geographic regions. Since a mobile multi-media broadcast system may generate broadcast signals in a multiplex signal generated in a headband facility at a central location, different alert sessions may be generated for each regional or local broadcast content. For example, there may be an emergency alert service session for a West Coast broadcast area and an East Coast broadcast area. There also may be an emergency alert service session for each local broadcast area, such as an emergency alert service session for San Diego and a different emergency alert service session for New York City. Regional and local OIS channel flows may provide information for the alert sessions in each location. An alert may also be received at a local broadcaster and inserted as an alert session into a local broadcast content, such as by an alert server within the local broadcast network.

The alert session layer at the head end facility or in a local broadcast network may provide the alert message delivery function to an application layer of the system. For example, the alert session layer may direct the application layer to start delivering alert messages in a particular region at a particular repetition rate, and terminate such messages at the appropriate time. The alert message session layer may also modify alert messages handled by the emergency alert system application layer by issuing commands to stop an earlier alert message and to start a new message, for example. Similarly, an alert message cancellation may be achieved by the application layer by the alert session layer issuing a stop command related to the earlier alert message and a start command related to a new alert message, for example.

An alert session layer within the receiver device may receive multiple copies of alert messages which may be processed in an emergency alert system application layer operating within the receiver device software. The emergency alert system application layer within the receiver device may be responsible for detecting duplicate alert messages to avoid generating multiple alerts for users as well as conserve battery power.

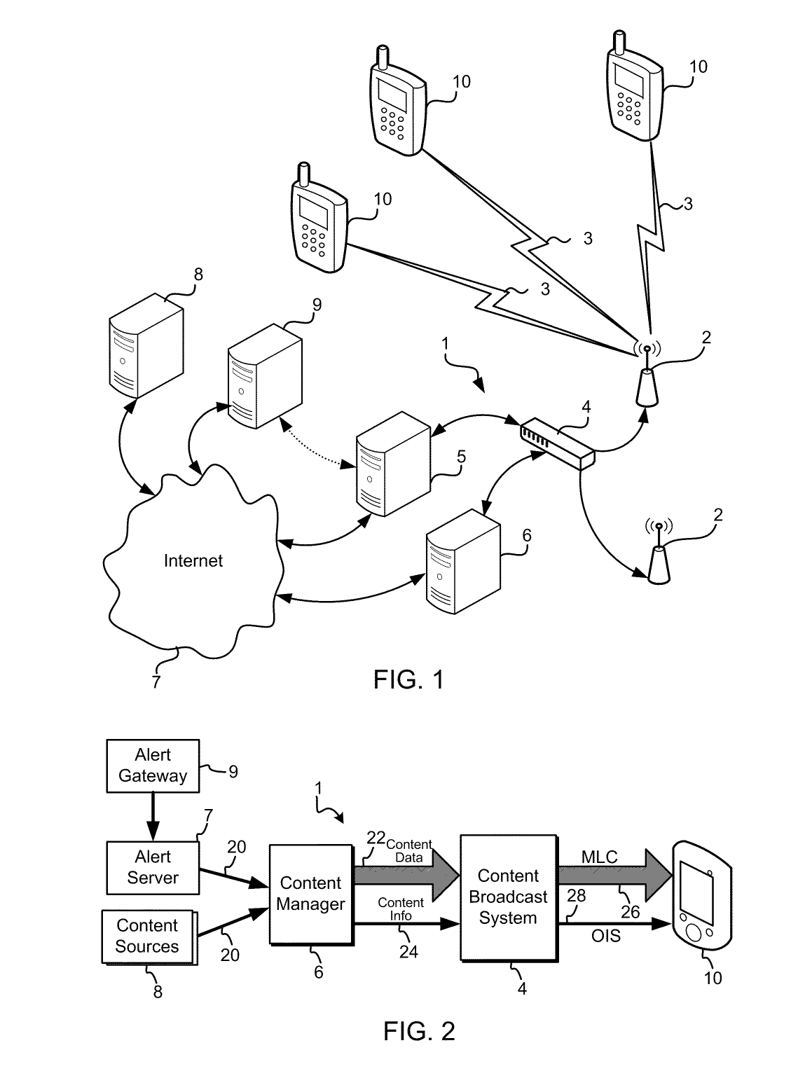

Example components of a typical FLO broadcast system 1 are illustrated in FIG. 1. A FLO broadcast network 1 typically includes a plurality of broadcast transmitters 2 controlled by a mobile broadcast network control center 4. The FLO broadcast network 1 broadcasts content from the broadcast transmitters 2 as mobile broadcast transmissions 3 for reception by receiver devices 10, such as smartphones, cellular phones, personal digital assistants (PDA), interactive game devices, notebooks, smartbooks, netbooks, mobile television devices, data processing apparatus, or other such electronic devices. Within the mobile broadcast network control center 4 will typically be one or more servers 6 which may be configured to manage the scheduling of content broadcasts, generation of electronic service guides and other metadata regarding the content broadcasts, and generation of metadata messages for broadcast via the overhead flow of the FLO multimedia broadcast network 1. One or more servers 6 may also include connections to an external network, such as the Internet 7, through which the server 6 may receive content feeds from content provider servers 8. One or more servers 6 may be configured according to the various embodiments to receive content from content provider servers 8, determine information about the received content to be included in metadata, determine a schedule for broadcast of the content in content batches, generate metadata messages including metadata regarding the content (including broadcast times), determine a time for a next update of the metadata, include information regarding the time for the next metadata update in the metadata messages, and provide the metadata messages to the FLO broadcast network 1 for broadcast to receiver devices 10.

In addition to the normal content delivery system, the FLO broadcast network 1 may also include an alert server 5 for connecting to an alert gateway 9. In a typical implementation, the alert gateway 9 may be one or more servers operated by a government agency or other entity under contract to the government to delivery emergency alert messages, such as emergency broadcast alerts, Amber Alerts, etc. A form of alert gateway 9 already exists to deliver emergency messages to radio and television stations for broadcast to the public. The alert server 5 may be a commercially available server configured with software according to the embodiments to receive emergency alert notifications from the alert gateway 9 and to configure the information for broadcast via the FLO broadcast network 1, as described herein. The alert server 5 may connect to the alert gateway 9 via the Internet and/or another network (e.g., the Emergency Broadcasting System) similar to how other types of broadcast systems couple to the alert gateway 9.

FIG. 2 illustrates information flows within a FLO broadcast network 1 according to an embodiment. As mentioned above, a FLO broadcast network 1 may receive content (e.g., television programs websites, serial data feeds, etc.) from a number of content sources 8. Such content may be provided to a content manager server 6 within a FLO broadcast network 1 via data networks 20 (e.g., the Internet 7). The content manager server 6 may store such content in a database and schedule the content for broadcast. The content manager 6 may provide content data 22 and information about the content 24 to the content broadcast system 4, where the broadcast signal is generated as a multiplex of information that includes the MLC channel 26 and the OIS channel 28. Receiver devices 10 can receive the multiplex signal and can separately receive the OIS channel 28 and other overhead information streams (e.g., a control channel) and use that information to receive a particular MLC channel 26.

Referring to FIG. 3A, in a typical multimedia mobile broadcast system, information is transmitted in a plurality of superframes 30. FIG. 3A illustrates a superframe in terms of boxes representing information encoded within portions of the superframe signal, with the vertical dimension representing the frequency bandwidth (“f”) and the horizontal dimension representing time. Each superframe is a signal within a frequency band and within set time boundaries that comprises a plurality of data packets that communicate the broadcast content along with overhead information used by receiver devices to receive selected content. For example, in the MediaFLO® by Qualcomm, Incorporated (San Diego, Calif.) broadcast system, broadcast transmissions are organized into one second superframes 30 spanning a frequency band (for example 716 MHz to 722 MHz). FLO broadcast signals may be sent on other frequency bands and multiple signals may be sent simultaneously by using multiple distinct frequency bands. Each superframe 30 includes a portion dedicated to the OIS channel 32 and a portion that carries multiple MLC channels (38a, 38b, 38c, etc.). Within each MLC channel (e.g., 38a) there may be up to three streams of content (not shown). As mentioned above, information within the OIS channel 32 informs receiver devices of where within the superframe that particular MLC can be obtained, as well as how many packets are associated with the streams of the MLC. FIG. 3A provides a high level illustration of how information may be carried within a superframe. Further details of the FLO signal are specified in TIA-1099 which is incorporated by reference.

Receiver devices which are not actively accessing a particular session or content will monitor the OIS channel 32 to receive information about the content being broadcast or that will be broadcast in the future. Receiver devices that are battery-powered typically monitor the OIS channel 32 periodically, such as once every 5 seconds, so that the receiver can be turned off for the majority of the time when the device is not actively receiving a particular service. Receiver devices that are not battery-power limited, such as receivers within automobiles, may monitor the OIS channel 32 at all times. Receiver devices that are receiving a service data flow (i.e., a particular program or content feed carried within the MLC channel) need not receive the OIS channel 32, since the receiver can get the OIS information from the embedded OIS information in the MLC channel it is receiving to obtain the service data flow.

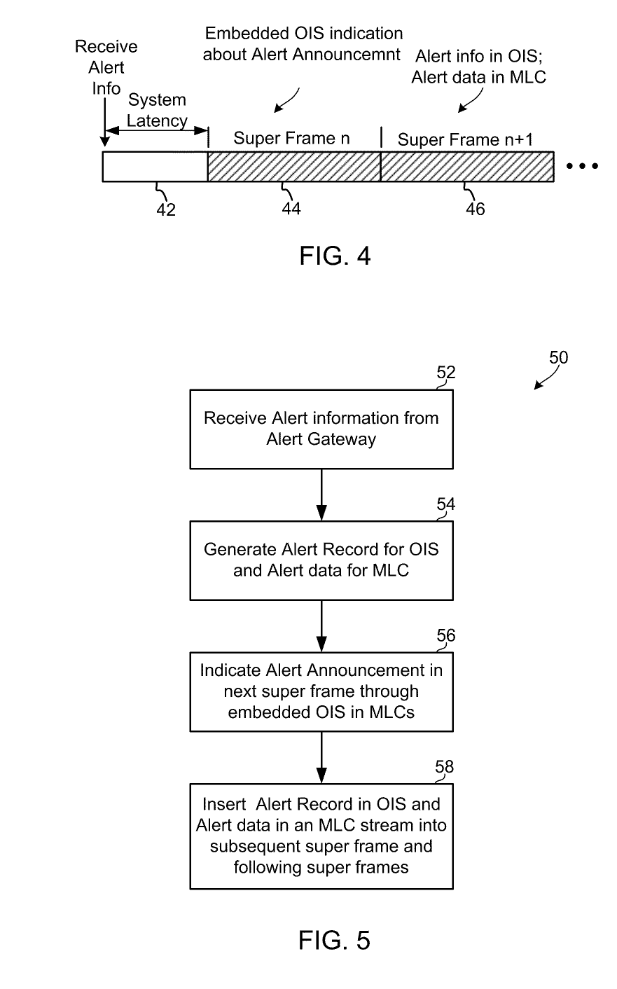

In view of this typical operational pattern of FLO broadcast networks, various embodiments may place information about alert messages within the OIS channel 32 and within the MLC channel (38a, 38b, 38c) as illustrated in FIG. 3B. Alert message acquisition information 42 may be included in the components of the OIS channel 32, which informs receiver devices that an alert message is included in the MLC channel and provides the information that the receiver device needs to access and receive the alert message. As described below, the alert message acquisition information (which is also referred to herein as the “alert record”) may be communicated in just a few bits (e.g., 6-7 bits), which is sufficient information to enable the receiver device to determine that an alert message is present and whether the alert message has already been received. As described more fully below with reference to FIGS. 4 and 5, alert message acquisition information may also be included within broadcast streams in the MLCs (38a, 38b, 38c, etc.) using the capability referred to in TIA-1099 as “embedded OIS.” The embedded OIS capability may alternatively be used to inform receiver devices that they need to receive the OIS in the next superframe to receive the updated alert record. This is illustrated in crosshatch areas in FIG. 3B which shows how alert message acquisition information 44 may be included within MLCs (38a, 38b, 38c, etc.). Additionally, the alert message data may be included in alert message packets 46a, 46b carried within a stream in an MLC (48). The timing and nature of the alert message acquisition information and alert message data packets are described more fully below.

An example of the data fields that may be added to the OIS channel to carry the alert message acquisition information is illustrated in Table 1 below.

TABLE 1

| | |
|---|---|
| Field | Length (bits) |

AlertRecord

| | |
|---|---|
| AlertSessionActive | 1 |

If AlertSessionActive = ‘l’, include the following 6 fields:

| | |
|---|---|
| AlertSessionID | 32 |
| NumAlertPackets | 16 |
| MLC_ID | 8 |
| TransmitMode | 4 |
| OuterCode | 4 |
| StreamID | 2 |

The example data structure for the alert message acquisition information illustrated in Table 1 illustrates how a single bit, namely the AlertSessionActive field, can be used to indicate whether there are alert messages being transmitted. For example, if a ‘1’ appears in the AlertSessionActive field, the OIS may include the additional listed information including, e.g., the alert session ID, the number of alert message packets within the alert session, the MLC ID, information regarding the message transmission characteristics needed to be able to receive the alert messages, and the Stream identifier which indicates the stream within the MLC where the alert packets can be found.

An example packet definition for an alert service session packet is illustrated in the following XML definition:

```
AlertSessionHeader {
    PacketType
    SessionID
    PacketId
    AlertType
    }
Payload
```

In this example data structure, the packet type (PacketType) may be an eight bit value which may be set equal to zero. The SessionID field may be a 32-bit identifier for every alert session that uniquely identifies the combined set of alert messages of the session. The head end will not reuse session IDs across the significant period of time. (Note that even if a session is created every second the 32-bit session ID length can provide enough unique identifiers for 136 years.) The packet ID may be a unique identifier which identifies a particular alert packet within an alert session. The packet ID may have values from 0 to 1 less than the number of alert packets, and can be used by the receiver device to place received packets in order and confirm that all alert packets have been received. As noted above, the number of alert packets may be sent in the OIS so the receiving device knows how many alert packets to receive. The head end need not assign the same packet ID to the same alert message across two different sessions. The AlertType may be a unique identifier identifying the type of emergency alert associated with the message (e.g., weather, earthquake, tsunami, Amber, etc.) and may be used to identify an appropriate alert application that the receiving device can use to receive and display the alert message. The alert type value may also be used to filter alerts so that only those relevant to the particular user are displayed, as described more fully below with reference to FIG. 10. Finally, the payload may contain the data that provides the text and information of the alert that the receiving device can use to display an appropriate alert message to a user.

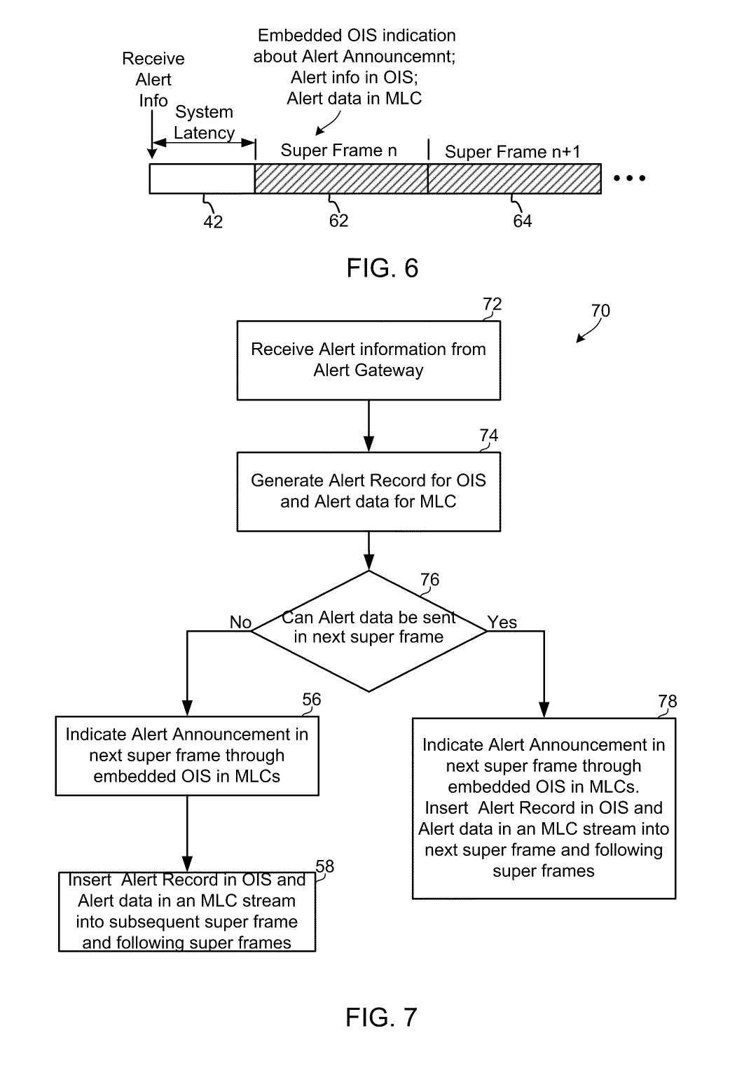

In order to minimize the time delay from the activation of an alert to reception by receiver devices, the various embodiments enable reception of an alert message within two superframes following the initial processing of alert information from an alert gateway. In a first embodiment illustrated in FIGS. 4 and 5, the alert message is included in the second superframe after processing of the alert information. In a second embodiment illustrated in FIGS. 6 and 7, the alert message may be included within the first superframe after processing of the alert information if there is available bandwidth or if another content data stream can be dropped.

FIG. 4 illustrates a timeline for implementing an alert message according to a first embodiment, with time measured in terms of superframes, which are one-second in duration in a MediaFLO® broadcast system. When alert information is received from an alert gateway, such as the issuance of an alert by a government agency, the alert server 5 and other elements of the broadcast network require some time to receive, authenticate, and parse the alert information, and to use that information to generate the alert acquisition information to be included in the OIS channel and the alert message data to be broadcast in an MLC channel. This necessary processing time is referred to herein as the system latency 42. The system latency can be reduced by increasing the processing speed or by reducing the number of operations required to prepare the alert message packets and OIS information. Once the alert acquisition information and alert message data are ready for broadcast (i.e., at the end of the system latency 42), the FLO broadcast network may include an announcement in the next superframe 44 to inform receiver devices that alert message and alert acquisition information in OIS will be included in the subsequent superframe 46. This announcement that an alert will be coming may be included within MLC channels as embedded OIS information. As noted above, the announcement inserted as embedded OIS may simply indicate that the receiving device should monitor the OIS in the subsequent superframe. Placing an announcement within the MLC channels as embedded OIS ensures that receivers that are on and receiving a service flow from an MLC channel (and thus are not intending to monitor the OIS channel in the subsequent superframe) will monitor the OIS in the subsequent superframe to receive alert acquisition information and alert message packets included in the subsequent superframe 46. Then, in the subsequent superframe 46, and all superframes thereafter so long as the alert remains in effect, the FLO broadcast network inserts the alert record information into the OIS and the alert message packets into its MLC channel. Thus, this embodiment enables receiver devices that are receiving a data MLC to receive the alert message within the second superframe 46 following the end of the system latency 42. This embodiment also enables receiver devices that are monitoring the OIS every superframe to receive the alert message within the second superframe 46 following the end of the system latency 42.

FIG. 5 illustrates an example method 50 that may be implemented within a FLO broadcast network, such as within an alert server 5, in order to insert the alert acquisition information and alert message data into the broadcast stream as illustrated in FIG. 4. In method 50, when the alert server 5 receives alert information from an alert gateway or other source of alert information, step 52, the alert server may use the received information to generate the alert record for inclusion in the OIS and the alert message data packets for inclusion in the MLC channel, step 54. This process may involve parsing the received information to determine the nature of the alert and the amount of data required to transmit the message, and formatting the information into the required packet formats. As part of this process, the FLO broadcast network may assign the alert message to a new alert session, and assign it a unique alert session ID. Once the information is available and processed into the proper format, the FLO broadcast network may announce the Alert in the next superframe in the MLCs as embedded OIS, step 56. As noted above, the information inserted as embedded OIS may simply indicate that the receiving device should monitor the OIS in the subsequent superframe. In the subsequent and following superframes, the FLO broadcast network inserts the alert record into the OIS and the alert data packets into an alert stream within a MLC channel, step 58.

FIG. 6 illustrates the timeline of a second embodiment for promptly including alert messages in the broadcast stream. In this embodiment, as part of the processing of alert information, the FLO broadcast network may determine whether there is bandwidth available for immediately inserting the alert message packets. If bandwidth is not available, the network may determine whether any of the current content can be dropped in order to make room for inserting the alert message packets. Once the alert acquisition information and alert message data are ready for broadcast (i.e., at the end of the system latency 42), if there is available bandwidth or if some other content within the MLC channel can be dropped to make room for the alert data message packets, the alert message packets can be included in an Alert stream within an MLC channel in the next superframe 62 and all superframes thereafter, so long as the alert remains in effect. The FLO broadcast network may insert the alert record information into the OIS and an announcement about Alerts in the embedded OIS of all MLCs in the next superframe 62 and all those following it. Placing the alert record in the OIS and the alert message packets in an MLC in superframe 62 ensures that receiver devices that are on and monitoring the OIS channel can receive the alert message packets in superframe 62. Placing the alert announcement in embedded OIS of all MLC channels in superframe 62 enables receivers that are on and receiving a different service flow (and thus are not monitoring the OIS channel) to receive the alert message packets in the successive superframe 64. This embodiment ensures that receiver devices that are on can receive the alert message no later than the second superframe 64 following the end of the system latency 42. Thus, this embodiment enables receiver devices that are receiving a data MLC (service flow) to receive the alert message within the second superframe 64 following the end of the system latency 42. This embodiment also enables receiver devices that are monitoring the OIS every superframe to receive the alert message within the first superframe 62 following the end of the system latency 42.

FIG. 7 illustrates an example method 70 which may be implemented within a FLO broadcast network, such as within an alert server 5, in order to insert the alert acquisition information and alert message data into the broadcast stream as illustrated in FIG. 6. In method 70, when the alert server 5 receives alert information from an alert gateway or other source of alert information, step 72, the alert server may use the received information to generate the alert record for inclusion in the OIS channel and the alert message data packets for inclusion in the MLC channel, step 74. As discussed above, this process may involve parsing the received information to determine the nature of the alert and the amount of data required to transmit the message, and formatting the information into the required packet formats. As part of this process, the FLO broadcast network may assign the alert message to a new alert session, and assign to it a unique alert session ID. Once the information is available and processed into the proper format, the FLO broadcast network may determine whether there is sufficient bandwidth available in the next superframe to immediately insert the alert message packets and if not, whether some broadcast content can be dropped in order to make sufficient bandwidth available, determination step 76. If the FLO broadcast network determines that there is insufficient bandwidth available (i.e., determination step 76=“No”), the network may proceed as described above with reference to FIG. 5 by announcing the Alert in the next superframe in the MLCs as embedded OIS, step 56. Then in the subsequent and following superframes, the FLO broadcast network may insert the alert record into the OIS and the alert data packets into an alert stream within a MLC channel, step 58. If the FLO broadcast network determines that there is sufficient bandwidth available (i.e., determination step 76=“Yes”), the network may announce the Alert in the next superframe in the MLCs as embedded OIS. In the next and following superframes, the FLO broadcast network may insert the alert record into the OIS and the alert data packets into an alert stream within a MLC channel, step 78.

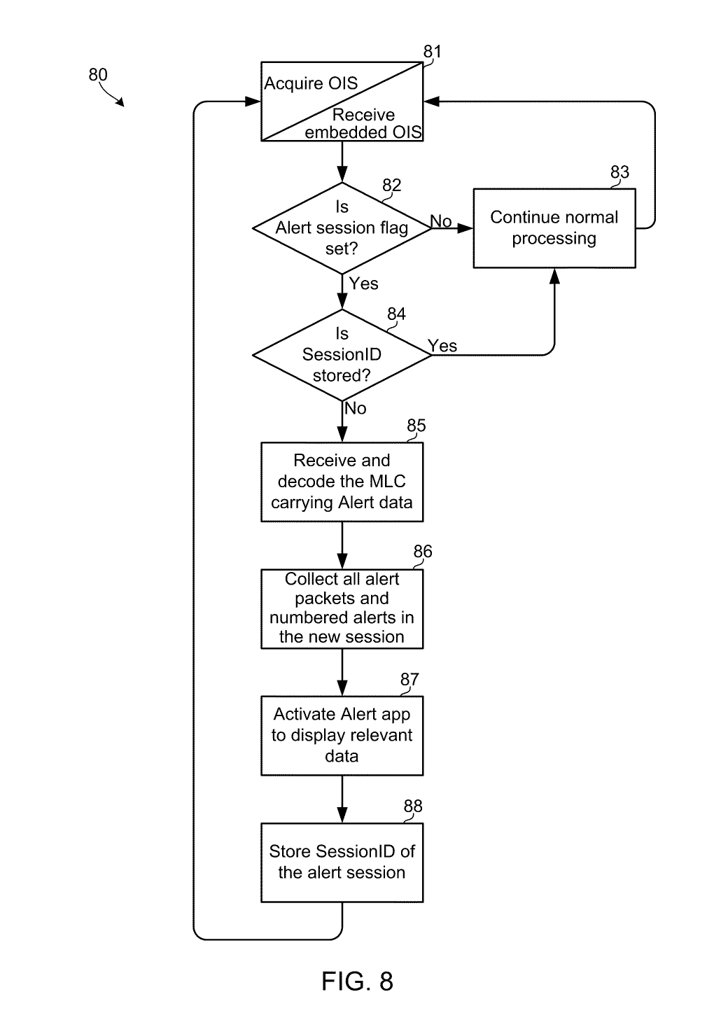

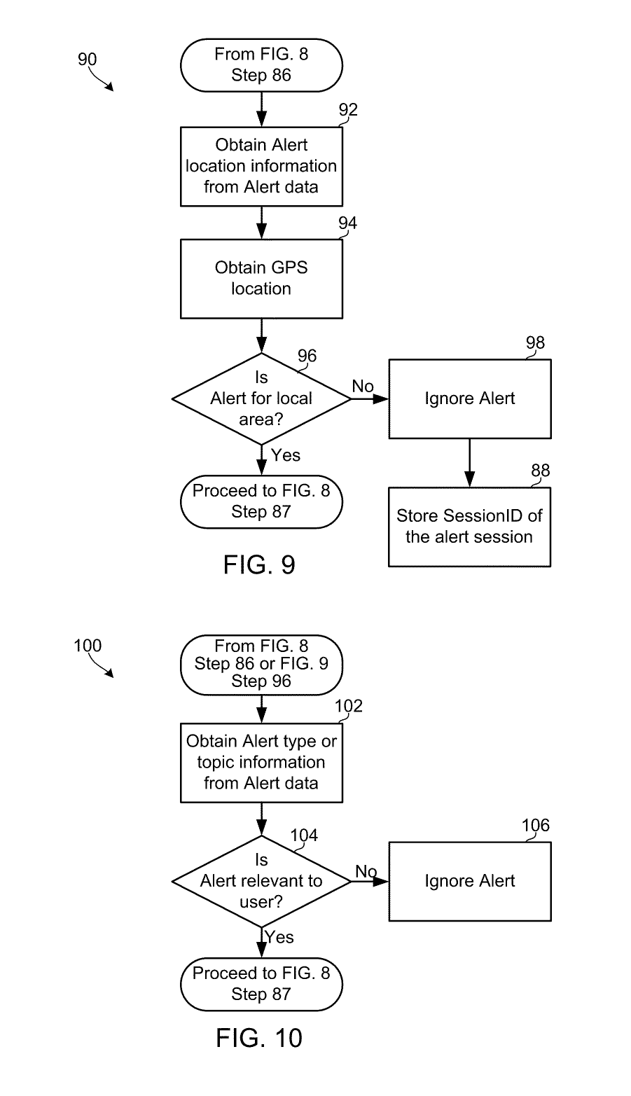

FIG. 8 shows a method 80 that may be used by receiver devices to receive alert messages inserted in the broadcast stream in the manner described above. As part of its normal operation, a FLO broadcast receiver device that is on will routinely acquire the OIS channel or will be actively receiving an MLC channel, step 81. If the receiver device is monitoring the OIS channel it will receive the alert record. If the receiver device is monitoring a service flow within a data MLC, and thus not checking the OIS, the receiver will receive an announcement of an Alert from embedded OIS information. Upon receiving the information in the OIS channel or from an embedded OIS message, the receiver checks the alert session flag (i.e., the AlertSessionActive value) in the OIS to see if it is set (i.e., whether AlertSessionActive=1), determination step 82. If the alert session flag is not set (i.e., determination step 82=“No”), no alert message processing is required so that the receiving device can continue with its normal processing, step 83, such as routinely acquiring the OIS channel or receiving a service flow in an MLC channel, returning to step 81 for the next superframe. If the receiver device determines that the alert session flag is set (i.e., determination step 82=“Yes”), the receiving device may obtain the session ID from the alert record information and determine whether that session ID number is stored in memory, determination step 84.

If the session ID is stored in memory (i.e., determination step 84=“Yes”), the receiving device has already received and processed the alert messages associated with the alert session ID, and thus there is no need to receive the same alert message packets, so the receiving device can continue with normal processing, step 83. However, if the receiving device determines that the received alert session ID is not stored in memory (i.e., determination step 84=“No”), this indicates that a new alert message is being received, in which case the receiving device may activate its receiver, if necessary, to receive and decode the MLC stream carrying the alert message data, step 85. The receiving device continues receiving the alert data until it collects all of the alert data packets for all of the alerts identified within the alert session, step 86. This process may extend beyond one superframe if the alert data is expansive or if there are several alert messages included in the same alert session.

Once all of the alert data packets for a particular alert message have been assembled, the receiving device may activate an appropriate alert application to display the relevant data to the user, step 87. Different applications may be used to process and display different types of alert messages, such as to provide different types of display graphics or enable user responses as may be appropriate for particular types of alerts. For example, due to the urgency and geographically limited nature of a tsunami, a tsunami warning alert may activate an application which can check the location of the receiver device to determine if it is in a threat area and, if so, activate a loud and vibrating alarm along with the display of evacuation directions. On the other hand, an air pollution alert, for which there is no real urgency, may activate a display that indicates the predicted hazard level without generating an audible warning. The receiver device may determine the appropriate alert application to invoke by using the alert type data included within the alert message data header. It is envisioned that application developers may coordinate with the authorities that issue alert warnings to agree upon a standard set of alert types that can be associated with alert applications and display/warning sounds which may be included in the software receiver devices.

Once the appropriate alert application has been activated in step 87, that application may be responsible for generating the appropriate displays, vibrations and sounds, as well as interacting with the user, such as, e.g., to receive an acknowledgment of the warning. Since there may be no need to receive the same alert message a second time, the receiving device may store the session ID of the particular alert session in memory, step 88. At this point, the receiver device may return to normal processing including receiving the next superframe to access the OIS or continue receiving a service flow in an MLC channel.

Since many alert messages will be relevant to only limited geographic areas, such as earthquake, tornado, tsunami or wildfire alerts, the receiver device may be configured to location information to identify relevant alert messages and to ignore irrelevant messages. FIG. 9 illustrates an example method 90 that may be implemented in receiver devices to filter alert messages based upon their location. When an alert message has been received (step 86 of FIG. 8), the receiver device may obtain any alert location information that is included within the received alert data, step 92. Such alert location information may be in the form of regional or local geographical region names, distances from a particular location, latitude and longitude coordinates or ranges, and other geographic information that may be recognized by receiver devices. When a message includes alert location information, the receiver device may obtain its current location, such as by accessing a Global Positioning System (GPS) receiver, step 94. The receiver device may then compare its current location to the alert location information to determine whether the alert message is pertinent to the location of the receiver device, determination step 96. This determination may use any known algorithm implemented in geographic information system (GIS) technologies. If the receiver device determines that the received alert is not pertinent to the location or surrounding area of the receiver device (i.e., determination step 96=“No”), the receiver device may simply ignore the alert message, step 98, and store the session ID of the alert session, step 88. If the receiver device determines that the received alert is pertinent to the location or surrounding area of the receiver device (i.e., determination step 96=“Yes”), the receiver device may process the alert message by implementing step 87 of FIG. 8 as described above.

Since many alert messages will be of little importance to some individuals, receiver devices may also be configured to filter alert messages for their relevance based on the type of alert being issued. For example, a user who has no respiratory ailments may have no interest in receiving air pollution alert messages. FIG. 10 shows a method 100 which may be implemented within receiver devices to filter alert messages based upon their type. When an alert message has been received (step 86 of FIG. 8) and, optionally, determined to be geographically relevant (determination step 96 of FIG. 9), the receiver device may obtain the alert type information from the received alert data, step 102. As mentioned above, the alert type may be any of a variety of types that may be identified by a number included in the 8-bit AlertType data field of an alert data message. By comparing the obtained alert type value to a list of relevant alert types, the receiver device may determine whether the alert is relevant to the user, determination step 104. This determination may be made by comparing the AlertType value to a list of alert type values stored in memory. In an embodiment, the receiver device may be configured to receive user settings indicating the types of alert messages that the user would like to receive or types of alert messages that the user would not like to receive. Thus, the comparison of the AlertType value to a list of stored values in memory may be used to determine relevancy based upon whether there is a match or no match to the stored values, for example. If the receiver device determines that the alert type is not relevant to the user (i.e., determination step 104=“No”), the receiver device may simply ignore the alert message, step 106, and can store the session ID of the alert session, such as in step 88. If the receiver device determines that the received alert is relevant to the user (i.e., determination step 104=“Yes”), the receiver device may process the alert message by implementing step 87 of FIG. 8 as described above.

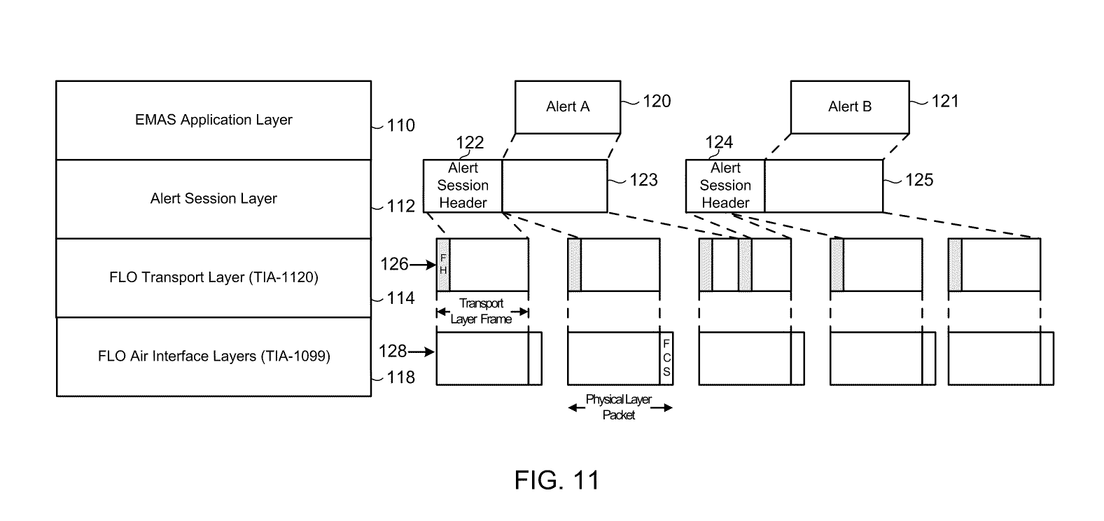

FIG. 11 graphically illustrates how alert messages received from an alert gateway can be reconfigured for broadcast over the FLO broadcast network. The left-hand side of FIG. 11 illustrates some of the software and hardware layers that may be implemented in a FLO broadcast network according to the various embodiments. An emergency alert system (EMAS) application layer 110 may be included within the system, such as within an alert server, for receiving and processing alerts received from an alert gateway or other alert issuing authority. The emergency alert system application layer 110 may receive alert information from the alert gateway, authenticate the information to confirm its source and accuracy, and provide the pertinent information to an alert session software layer 112 which may be configured to format the information into alert data messages and alert records for the OIS channel. The alert session layer may be in communication with the FLO transport layer 114 which formats information into superframes that are provided to the broadcast layer 118 (e.g., FLO air interface layer) for broadcast. As indicated in FIG. 11, the transport and broadcast layers may be defined by the TIA-1120 and TIA-1099 specifications.

Referring to the right-hand side of FIG. 11, an alert 120 received from the alert gateway may be assembled into an alert message 123 by the alert session layer 112. This process may involve appending an alert session header 122 to the alert received from the alert gateway. In the transport layer, the alert message 123 may be broken up into message packets 126 suitable for broadcast. As illustrated, this may involve breaking up an alert message 123 into multiple packets for transport (referred to as transport layer frames). Such transport layer frames may be provided to the broadcast layer 118 for broadcast as physical layer packets 128. As illustrated in FIG. 11, multiple alerts 120, 121 may be received, with the resulting transport and physical layer packets overlapping, or multiplexing, with information in one or more frame headers provided to enable the receiving device to receive and reassemble the original alert information. In order to enable receiving devices to identify and assemble alert data packets, the packets may be tagged with alert session packet tags, thereby allowing such packets to be multiplexed with other types of data packets. Thus, the various embodiments enable fragmentation of packets across superframes in the transport layer which helps to increase the utilization of the available bandwidth.

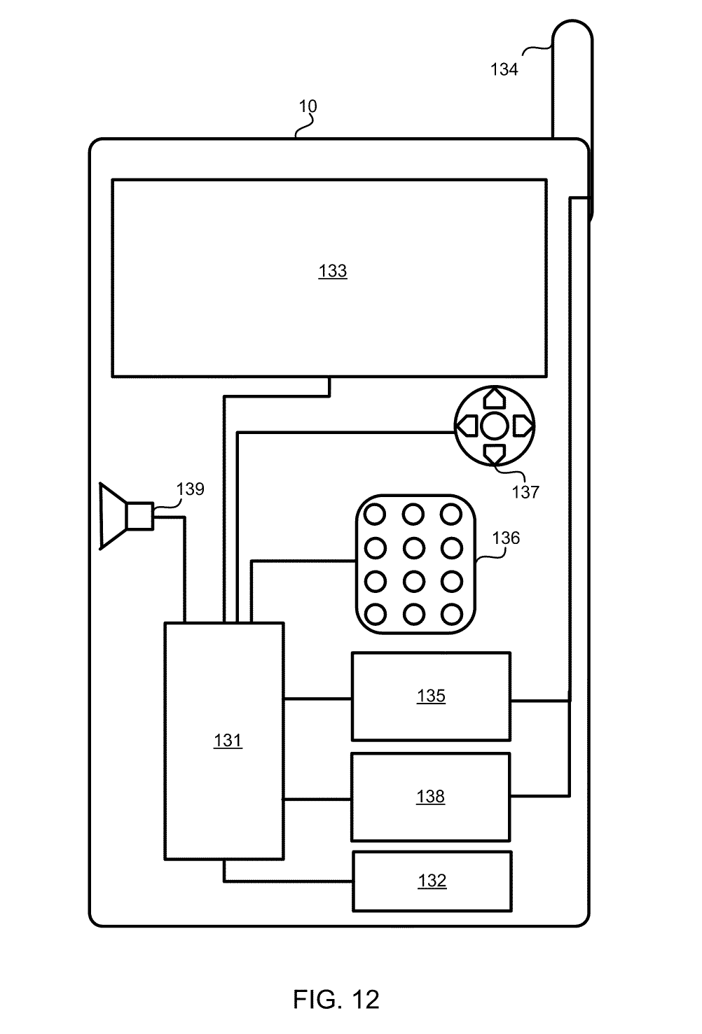

Typical receiver devices 10 suitable for use with the various embodiments will have in common the components illustrated in FIG. 12. For example, an exemplary receiver device 130 may include a processor 131 coupled to internal memory 132, to a display 133, and to a speaker 139. Additionally, the receiver device 10 may have an antenna 134 for sending and receiving electromagnetic radiation that is connected to a wireless data link and/or cellular telephone transceiver 135 coupled to the processor 131 and a FLO broadcast receiver 138 coupled to the processor 131. Receiver devices typically also include a key pad 136 or miniature keyboard, and menu selection buttons or rocker switches 137 for receiving user inputs.

The processor 131 may be any programmable microprocessor, microcomputer or multiple processor chip or chips that can be configured by software instructions (applications) to perform a variety of functions, including the functions of the various embodiments described herein. In some receiver devices, multiple processors 131 may be provided, such as one processor dedicated to wireless communication functions and one processor dedicated to running other applications. Typically, software applications may be stored in the internal memory 132 before they are accessed and loaded into the processor 131. In some receiver devices, the processor 131 may include internal memory sufficient to store the application software instructions. In some receiver devices, the secure memory may be in a separate memory chip coupled to the processor 131. The internal memory 132 may be a volatile or nonvolatile memory, such as flash memory, or a mixture of both. For the purposes of this description, a general reference to memory refers to all memory accessible by the processor 131, including internal memory 132, removable memory plugged into the device, and memory within the processor 131 itself.

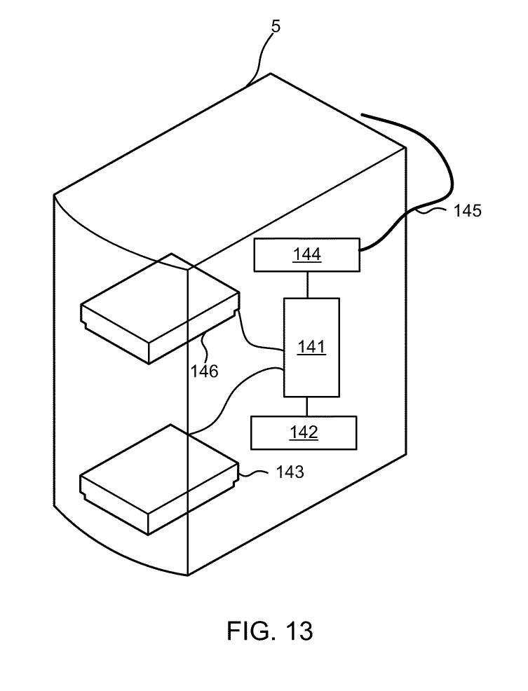

A number of the embodiments described above may also be implemented with any of a variety of commercially available remote server devices, such as the server 5 illustrated in FIG. 13. Such a server 5 typically includes a processor 141 coupled to volatile memory 142 and a large capacity nonvolatile memory, such as a disk drive 143. The server 5 may also include a floppy disc drive and/or a compact disc (CD) drive 146 coupled to the processor 141. The server 5 may also include network access ports 144 coupled to the processor 141 for establishing data connections with a network 145, such as the Internet.

The server processor 141 may be any programmable microprocessor, microcomputer or multiple processor chip or chips that can be configured by software instructions (applications) to perform a variety of functions, including the functions of the various embodiments described herein. Typically, software applications may be stored in the internal memory 142, 143 before they are accessed and loaded into the processor 141. The internal memory 142, 143 may be a volatile or nonvolatile memory, such as flash memory, or a mixture of both. For the purposes of this description, a general reference to memory refers to all memory accessible by the server processor 141, including internal memory 142, 143, remote memory and disc drives accessible by the server, removable memory plugged into the server, and memory within the processor 141 itself.

The foregoing embodiments provide an efficient and prompt mechanism for delivering alert messages to FLO broadcast network receivers that enable battery-operated receivers to process alerts without draining their battery. By providing the alert record in the OIS channel and using the embedded OIS option receiver devices can be informed of the presence of an alert message within two superframes after the system latency. The alert record in the OIS channel indicates the physical channel that the receiving device can use to acquire the alert data from the MLC stream, as well as the transmission characteristics of the corresponding physical channel. By providing alert messages in alert sessions identified by an alert session ID and indicating a number of alert data packets as well as number of alerts within the session in the alert data packets, receiving devices can determine quickly when they have received all data packets associated with a particular alert so that the receiving device can ignore subsequent broadcasts of the same alert, thereby enabling it to avoid draining the battery by receiving redundant alert messages. This enables the FLO broadcast network to broadcast alerts frequently in order to inform receiver devices as soon as they are turned on without draining the batteries of other receiver devices from unnecessary processing of redundant alert messages or constant monitoring for detecting alerts. The embodiments also enable effective utilization of broadcast bandwidth for delivering alert messages by enabling alert messages to be multiplexed with other streams. Thus, if an alert message does not fill the minimum size for an MLC (e.g., 16 kilobits per superframe), the alert can be multiplexed with other streams into an MLC to effectively utilize the available bandwidth. Alert session packet tags can be used to identify packets associated with alert data messages so that the packets can be multiplexed with packets of different types of content into a stream.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a tangible computer-readable storage medium. Computer-readable storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for delivering emergency alert content in a forward link only (FLO) broadcast network, comprising:
generating an alert record for inclusion in an overhead information symbol (OIS) channel, the alert record including an alert session identifier and information useful for receiving an alert data record in a multicast logic channel (MLC);
generating an alert message for broadcast in an MLC;
broadcasting an alert announcement in an embedded OIS message in a first superframe;
broadcasting the alert record in the OIS channel; and
broadcasting the alert message in the MLC.

2. The method of claim 1, further comprising:
receiving a broadcast from the FLO broadcast network in a receiver device;
determining whether the broadcast includes an alert record;
obtaining the alert session identifier from the alert record if it is determined that the OIS channel includes an alert record;
determining whether the alert session identifier is stored in memory of the receiver device; and
receiving the alert message if it is determined that the alert session identifier is not stored in memory.

3. The method of claim 2, wherein determining whether a broadcast from the FLO broadcast network includes an alert record comprises:
receiving the OIS channel in a receiver device; and
determining whether the OIS channel includes an alert record.

4. The method of claim 2, wherein determining whether a broadcast from the FLO broadcast network includes an alert record comprises:
receiving an embedded OIS message within an MLC.

5. The method of claim 1, wherein:
broadcasting the alert record in the OIS channel comprises broadcasting the alert record in the second superframe and subsequent superframes; and
broadcasting the alert message in the MLC comprises broadcasting the alert message in the MLC in a second superframe and subsequent superframes.

6. The method of claim 1, further comprising:
determining whether sufficient bandwidth exists or can be obtained to broadcast the alert message in the first superframe;
broadcasting the alert record in the OIS channel in the first superframe and subsequent superframes; and
broadcasting the alert message in the first superframe if it is determined that sufficient bandwidth exists or can be obtained to broadcast the alert message in the first superframe.

7. The method of claim 2, further comprising:
including geographic information in the alert message;
obtaining the geographic information from the alert message at the receiver device;
determining a location of the receiver device;
comparing the determined location of the receiver device to the obtained geographic information to determine if the alert message is pertinent; and
processing the alert message if it is determined to be pertinent.

8. The method of claim 2, further comprising:
including an alert type information in the alert message;
obtaining the alert type information from the alert message at the receiver device;
comparing the obtained alert type information to information stored in memory to determine if the alert message is relevant to a user of the receiver device; and
processing the alert message if it is determined to be relevant to the user of the receiver device.

9. The method of claim 8, further comprising:
receiving user settings indicating alert types that the user considers to be relevant; and
storing the received user settings in memory.

10. The method of claim 8, further comprising:
receiving user settings indicating alert types that the user considers to be irrelevant; and
storing the received user settings in memory.

11. The method of claim 1, wherein the alert announcement broadcasted in an embedded OIS message in the first superframe comprises the alert record.

12. The method of claim 1, wherein the alert announcement broadcasted in an embedded OIS message in the first superframe indicates that the OIS channel is changing in the next superframe.

13. The method of claim 1, wherein the steps of receiving the emergency alert, generating the alert record and generating the alert message are accomplished at a head end facility.

14. The method of claim 1, wherein the steps of receiving the emergency alert, generating the alert record and generating the alert message are accomplished at a local broadcast facility.

15. A server for use in a forward link only (FLO) broadcast network, comprising:
a processor; and
a network access port coupled to the processor and configured to couple the processor to a network,
wherein the processor is configured with processor executable instructions to perform steps comprising:
generating an alert record for inclusion in an overhead information symbol (OIS) channel, the alert record including an alert session identifier and information useful for receiving an alert data record in a multicast logic channel (MLC);
generating an alert message for broadcast in an MLC;
initiating broadcast of an alert announcement in an embedded OIS message in a first superframe;
initiating broadcast of the alert record in the OIS channel; and
initiating broadcast of the alert message in the MLC.

16. The server of claim 15, wherein the processor is configured with processor executable instructions such that:
initiating broadcast of the alert record in the OIS channel comprises initiating broadcast of the alert record in the second superframe and subsequent superframes; and
initiating broadcast of the alert message in the MLC comprises initiating broadcast of the alert message in the MLC in a second superframe and subsequent superframes.

17. The server of claim 15, wherein the processor is configured with processor executable instructions to perform steps further comprising:
determining whether sufficient bandwidth exists or can be obtained to broadcast the alert message in the first superframe;
initiating broadcast of the alert record in the OIS channel in the first superframe and subsequent superframes; and
initiating broadcast of the alert message in the first superframe if it is determined that sufficient bandwidth exists or can be obtained to broadcast the alert message in the first superframe.

18. The server of claim 15, wherein the processor is configured with processor executable instructions to perform steps further comprising:
including geographic information in the alert message.

19. The server of claim 15, wherein the processor is configured with processor executable instructions to perform steps further comprising:
including an alert type information in the alert message.

20. The server of claim 15, wherein the processor is configured with processor executable instructions such that the alert announcement broadcasted in an embedded OIS message in the first superframe comprises the alert record.

21. The server of claim 15, wherein the processor is configured with processor executable instructions such that the alert announcement broadcasted in an embedded OIS message in the first superframe indicates that the OIS channel is changing in the next superframe.

22. A receiver device configured to receive emergency alert content in broadcasts a forward link only (FLO) broadcast, comprising:
a processor;
a memory coupled to the processor; and
a receiver coupled to the processor and configured to receive broadcasts from a FLO broadcast network,
wherein the processor is configured with processor-executable instructions to perform steps comprising;
receiving a broadcast from the FLO broadcast network;
determining whether the broadcast includes an alert record;
obtaining an alert session identifier from the alert record if it is determined that an OIS channel includes an alert record;
determining whether the alert session identifier is stored in the memory; and
receiving the alert message if it is determined that the alert session identifier is not stored in the memory.

23. The receiver device of claim 22, wherein the processor is configured with processor-executable instructions such that determining whether a broadcast from the FLO broadcast network includes an alert record comprises:
receiving the OIS channel; and
determining whether the OIS channel includes an alert record.

24. The receiver device of claim 22, wherein the processor is configured with processor-executable instructions such that determining whether a broadcast from the FLO broadcast network includes an alert record comprises:
receiving an embedded OIS message within an MLC.

25. The receiver device of claim 22, wherein the processor is configured with processor-executable instructions to perform steps further comprising:
obtaining geographic information from the alert message;
determining a location of the receiver device;
comparing the determined location of the receiver device to the obtained geographic information to determine if the alert message is pertinent; and
processing the alert message if it is determined to be pertinent.

26. The receiver device of claim 22, wherein the processor is configured with processor-executable instructions to perform steps further comprising:
obtaining an alert type information from the alert message;
comparing the obtained alert type information to information stored in the memory to determine if the alert message is relevant to a user of the receiver device; and
processing the alert message if it is determined to be relevant to the user of the receiver device.

27. The receiver device of claim 26, wherein the processor is configured with processor-executable instructions to perform steps further comprising:
receiving user settings indicating alert types that the user considers to be relevant; and
storing the received user settings in the memory.

28. The receiver device of claim 26, wherein the processor is configured with processor-executable instructions to perform steps further comprising:
receiving user settings indicating alert types that the user considers to be irrelevant; and
storing the received user settings in the memory.

29. A communication system, comprising:
a forward link only (FLO) broadcast network; and
a receiver device,
wherein the FLO broadcast network is configured to perform processes comprising:
receiving an emergency alert;
generating an alert record for inclusion in an overhead information symbol (OIS) channel, the alert record including an alert session identifier and information useful for receiving an alert data record in a multicast logic channel (MLC);
generating an alert message for broadcast in an MLC;
broadcasting an alert announcement in an embedded OIS message in a first superframe;
broadcasting the alert record in the OIS channel; and
broadcasting the alert message in the MLC, and
wherein the receiving device comprises:
a processor;
a memory coupled to the processor; and
a receiver coupled to the processor and configured to receive broadcasts from a FLO broadcast network,
wherein the processor is configured with processor-executable instructions to perform steps comprising;
receiving a broadcast from the FLO broadcast network;
determining whether the broadcast includes an alert record;
obtaining the alert session identifier from the alert record if it is determined that the OIS channel includes an alert record;
determining whether the alert session identifier is stored in memory of the receiver device; and
receiving the alert message if it is determined that the alert session identifier is not stored in memory.

30. The communication system of claim 29, wherein the processor is configured with processor-executable instructions such that determining whether a broadcast from the FLO broadcast network includes an alert record comprises:
receiving the OIS channel in a receiver device; and
determining whether the OIS channel includes an alert record.

31. The communication system of claim 29, wherein the processor is configured with processor-executable instructions such that determining whether a broadcast from the FLO broadcast network includes an alert record comprises:
receiving an embedded OIS message within an MLC.

32. The communication system of claim 29, wherein the FLO broadcast network is configured such that:
broadcasting the alert record in the OIS channel comprises broadcasting the alert record in the second superframe and subsequent superframes; and
broadcasting the alert message in the MLC comprises broadcasting the alert message in the MLC in a second superframe and subsequent superframes.

33. The communication system of claim 29, wherein the FLO broadcast network is configured to perform further steps further comprising:
determining whether sufficient bandwidth exists or can be obtained to broadcast the alert message in the first superframe;
broadcasting the alert record in the OIS channel in the first superframe and subsequent superframes; and
broadcasting the alert message in the first superframe if it is determined that sufficient bandwidth exists or can be obtained to broadcast the alert message in the first superframe.

34. The communication system of claim 29, wherein:
the FLO broadcast network is configured to perform steps further comprising including geographic information in the alert message; and
the processor is configured with processor-executable instructions to perform steps further comprising:
obtaining the geographic information from the alert message at the receiver device;
determining a location of the receiver device;
comparing the determined location of the receiver device to the obtained geographic information to determine if the alert message is pertinent; and
processing the alert message if it is determined to be pertinent.

35. The communication system of claim 29, wherein:
the FLO broadcast network is configured to perform steps further comprising including an alert type information in the alert message; and
the processor is configured with processor-executable instructions to perform steps further comprising:
obtaining the alert type information from the alert message at the receiver device;
comparing the obtained alert type information to information stored in memory to determine if the alert message is relevant to a user of the receiver device; and
processing the alert message if it is determined to be relevant to the user of the receiver device.

36. The communication system of claim 35, wherein the processor is configured with processor-executable instructions to perform steps further comprising:
receiving user settings indicating alert types that the user considers to be relevant; and
storing the received user settings in memory.

37. The communication system of claim 35, wherein the processor is configured with processor-executable instructions to perform steps further comprising:
receiving user settings indicating alert types that the user considers to be irrelevant; and
storing the received user settings in memory.

38. The communication system of claim 29, wherein the FLO broadcast network is configured such that the alert announcement broadcasted in an embedded OIS message in the first superframe comprises the alert record.

39. The communication system of claim 29, wherein the FLO broadcast network is configured such that the alert announcement broadcasted in an embedded OIS message in the first superframe indicates that the OIS channel is changing in the next superframe.

40. The communication system of claim 29, wherein the FLO broadcast network is configured such that the steps of receiving the emergency alert, generating the alert record and generating the alert message are accomplished at a head end facility.

41. The communication system of claim 29, wherein the FLO broadcast network is configured such that the steps of receiving the emergency alert, generating the alert record and generating the alert message are accomplished at a local broadcast facility.

42. A server for use in a forward link only (FLO) broadcast network, comprising:
means for generating an alert record for inclusion in an overhead information symbol (OIS) channel, the alert record including an alert session identifier and information useful for receiving an alert data record in a multicast logic channel (MLC);
means for generating an alert message for broadcast in an MLC;
means for initiating broadcast of an alert announcement in an embedded OIS message in a first superframe;
means for initiating broadcast of the alert record in the OIS channel; and
means for initiating broadcast of the alert message in the MLC.

43. The server of claim 42, wherein:
means for initiating broadcast of the alert record in the OIS channel comprises means for initiating broadcast of the alert record in the second superframe and subsequent superframes; and
means for initiating broadcast of the alert message in the MLC comprises means for initiating broadcast of the alert message in the MLC in a second superframe and subsequent superframes.

44. The server of claim 42, further comprising:
means for determining whether sufficient bandwidth exists or can be obtained to broadcast the alert message in the first superframe;
means for initiating broadcast of the alert record in the OIS channel in the first superframe and subsequent superframes; and
means for initiating broadcast of the alert message in the first superframe if it is determined that sufficient bandwidth exists or can be obtained to broadcast the alert message in the first superframe.

45. The server of claim 42, further comprising:
means for including geographic information in the alert message.

46. The server of claim 42, further comprising:
means for including an alert type information in the alert message.

47. The server of claim 42, wherein the alert announcement broadcasted in an embedded OIS message in the first superframe comprises the alert record.

48. The server of claim 42, wherein the alert announcement broadcasted in an embedded OIS message in the first superframe indicates that the OIS channel is changing in the next superframe.

49. A receiver device configured to receive emergency alert content in broadcasts a forward link only (FLO) broadcast, comprising:
means for receiving a broadcast from the FLO broadcast network;
means for determining whether the broadcast includes an alert record;
means for obtaining an alert session identifier from the alert record if it is determined that an OIS channel includes an alert record;
means for determining whether the alert session identifier is stored in the memory; and
means for receiving the alert message if it is determined that the alert session identifier is not stored in the memory.

50. The receiver device of claim 49, wherein means for determining whether a broadcast from the FLO broadcast network includes an alert record comprises:
means for receiving the OIS channel; and
means for determining whether the OIS channel includes an alert record.

51. The receiver device of claim 49, wherein means for determining whether a broadcast from the FLO broadcast network includes an alert record comprises:
means for receiving an embedded OIS message within an MLC.

52. The receiver device of claim 49, further comprising:
means for obtaining geographic information from the alert message;
means for determining a location of the receiver device;
means for comparing the determined location of the receiver device to the obtained geographic information to determine if the alert message is pertinent; and
means for processing the alert message if it is determined to be pertinent.

53. The receiver device of claim 49, further comprising:
means for obtaining an alert type information from the alert message;
means for comparing the obtained alert type information to information stored in the memory to determine if the alert message is relevant to a user of the receiver device; and
means for processing the alert message if it is determined to be relevant to the user of the receiver device.

54. The receiver device of claim 53, further comprising:
means for receiving user settings indicating alert types that the user considers to be relevant; and
means for storing the received user settings in the memory.

55. The receiver device of claim 53, further comprising:
means for receiving user settings indicating alert types that the user considers to be irrelevant; and
means for storing the received user settings in the memory.

56. A communication system, comprising:
means for generating an alert record for inclusion in an overhead information symbol (OIS) channel, the alert record including an alert session identifier and information useful for receiving an alert data record in a multicast logic channel (MLC);
means for generating an alert message for broadcast in an MLC;
means for broadcasting an alert announcement in an embedded OIS message in a first superframe;
means for broadcasting the alert record in the OIS channel;
means for broadcasting the alert message in the MLC;
means for receiving a broadcast from the FLO broadcast network;
means for determining whether the broadcast includes an alert record;
means for obtaining the alert session identifier from the alert record if it is determined that the OIS channel includes an alert record;
means for determining whether the alert session identifier is stored in memory of the receiver device; and
means for receiving the alert message if it is determined that the alert session identifier is not stored in memory.

57. The communication system of claim 56, wherein means for determining whether a broadcast from the FLO broadcast network includes an alert record comprises:
means for receiving the OIS channel in a receiver device; and
means for determining whether the OIS channel includes an alert record.

58. The communication system of claim 56, wherein means for determining whether a broadcast from the FLO broadcast network includes an alert record comprises:
means for receiving an embedded OIS message within an MLC.

59. The communication system of claim 56, wherein:
means for broadcasting the alert record in the OIS channel comprises means for broadcasting the alert record in the second superframe and subsequent superframes; and
means for broadcasting the alert message in the MLC comprises means for broadcasting the alert message in the MLC in a second superframe and subsequent superframes.

60. The communication system of claim 56, further comprising:
means for determining whether sufficient bandwidth exists or can be obtained to broadcast the alert message in the first superframe;
means for broadcasting the alert record in the OIS channel in the first superframe and subsequent superframes; and
means for broadcasting the alert message in the first superframe if it is determined that sufficient bandwidth exists or can be obtained to broadcast the alert message in the first superframe.

61. The communication system of claim 56, further comprising:
means for including geographic information in the alert message;
means for obtaining the geographic information from the alert message at the receiver device;
means for determining a location of the receiver device;
means for comparing the determined location of the receiver device to the obtained geographic information to determine if the alert message is pertinent; and
means for processing the alert message if it is determined to be pertinent.

62. The communication system of claim 56, further comprising:
means for including an alert type information in the alert message;
means for obtaining the alert type information from the alert message at the receiver device;
means for comparing the obtained alert type information to information stored in memory to determine if the alert message is relevant to a user of the receiver device; and
means for processing the alert message if it is determined to be relevant to the user of the receiver device.

63. The communication system of claim 62, further comprising:
means for receiving user settings indicating alert types that the user considers to be relevant; and
means for storing the received user settings in memory.

64. The communication system of claim 62, further comprising:
means for receiving user settings indicating alert types that the user considers to be irrelevant; and
means for storing the received user settings in memory.

65. The communication system of claim 56, wherein means for broadcasting an alert announcement in an embedded OIS message in a first superframe comprises means for broadcasting the alert announcement in an embedded OIS message in the first superframe including the alert record.

66. The communication system of claim 62, wherein means for broadcasting an alert announcement in an embedded OIS message in a first superframe comprises means for broadcasting the alert announcement in an embedded OIS message in the first superframe indicating that the OIS channel is changing in the next superframe.

67. The communication system of claim 62, wherein means for receiving the emergency alert, means for generating the alert record and means for generating the alert message are located at a head end facility.

68. The communication system of claim 62, means for receiving the emergency alert, means for generating the alert record and means for generating the alert message are located at a local broadcast facility.

69. A computer program product, comprising:
a computer-readable storage medium comprising:
at least one instruction for receiving an emergency alert via the network;
at least one instruction for generating an alert record for inclusion in an overhead information symbol (OIS) channel, the alert record including an alert session identifier and information useful for receiving an alert data record in a multicast logic channel (MLC);
at least one instruction for generating an alert message for broadcast in an MLC;
at least one instruction for initiating broadcast of an alert announcement in an embedded OIS message in a first superframe;
at least one instruction for initiating broadcast of the alert record in the OIS channel; and
at least one instruction for initiating broadcast of the alert message in the MLC.

70. The computer program product of claim 69, wherein:
the at least one instruction for initiating broadcast of the alert record in the OIS channel comprises at least one instruction for initiating broadcast of the alert record in the second superframe and subsequent superframes; and
the at least one instruction for initiating broadcast of the alert message in the MLC comprises at least one instruction for initiating broadcast of the alert message in the MLC in a second superframe and subsequent superframes.

71. The computer program product of claim 69, wherein the computer-readable storage medium further comprises:
at least one instruction for determining whether sufficient bandwidth exists or can be obtained to broadcast the alert message in the first superframe;
at least one instruction for initiating broadcast of the alert record in the OIS channel in the first superframe and subsequent superframes; and
at least one instruction for initiating broadcast of the alert message in the first superframe if it is determined that sufficient bandwidth exists or can be obtained to broadcast the alert message in the first superframe.

72. The computer program product of claim 69, wherein the computer-readable storage medium further comprises:
at least one instruction for including geographic information in the alert message.

73. The computer program product of claim 69, wherein the computer-readable storage medium further comprises:
at least one instruction for including an alert type information in the alert message.

74. The computer program product of claim 69, wherein the at least one instruction for initiating broadcast of an alert announcement in an embedded OIS message in a first superframe comprises at least one instruction for initiating broadcast of an alert announcement in an embedded OIS message including the alert record.

75. The computer program product of claim 69, wherein the at least one instruction for initiating broadcast of an alert announcement in an embedded OIS message in a first superframe comprises at least one instruction for initiating broadcast of an alert announcement in an embedded OIS message indicating that the OIS channel is changing in the next superframe.

76. A computer program product, comprising:
a computer-readable storage medium comprising:
at least one instruction for receiving a broadcast from the FLO broadcast network;
at least one instruction for determining whether the broadcast includes an alert record;
at least one instruction for obtaining an alert session identifier from the alert record if it is determined that an OIS channel includes an alert record;
at least one instruction for determining whether the alert session identifier is stored in the memory; and
at least one instruction for receiving the alert message if it is determined that the alert session identifier is not stored in the memory.

77. The computer program product of claim 76, wherein the at least one instruction for determining whether a broadcast from the FLO broadcast network includes an alert record comprises:
at least one instruction for receiving the OIS channel; and
at least one instruction for determining whether the OIS channel includes an alert record.

78. The computer program product of claim 76, wherein the at least one instruction for determining whether a broadcast from the FLO broadcast network includes an alert record comprises:
at least one instruction for receiving an embedded OIS message within an MLC.

79. The computer program product of claim 76, wherein the computer-readable storage medium further comprises:
at least one instruction for obtaining geographic information from the alert message;
at least one instruction for determining a location of the receiver device;
at least one instruction for comparing the determined location of the receiver device to the obtained geographic information to determine if the alert message is pertinent; and
at least one instruction for processing the alert message if it is determined to be pertinent.

80. The computer program product of claim 76, wherein the computer-readable storage medium further comprises:
at least one instruction for obtaining an alert type information from the alert message;
at least one instruction for comparing the obtained alert type information to information stored in the memory to determine if the alert message is relevant to a user of the receiver device; and
at least one instruction for processing the alert message if it is determined to be relevant to the user of the receiver device.

81. The computer program product of claim 80, wherein the computer-readable storage medium further comprises:
at least one instruction for receiving user settings indicating alert types that the user considers to be relevant; and
at least one instruction for storing the received user settings in the memory.

82. The computer program product of claim 80, wherein the computer-readable storage medium further comprises:
at least one instruction for receiving user settings indicating alert types that the user considers to be irrelevant; and
at least one instruction for storing the received user settings in the memory.
